(19) United States
(12) Patent Application Publication
(10) Pub. No.: US 2017/0078830 A1
(43) Pub. Date: Mar. 16, 2017

(54) Methods and Apparatus for Resource Allocation

(71) Applicant: MEDIATEK Singapore Pte. Ltd., Singapore (SG)

(72) Inventors: Min Wu, Beijing (CN); Feifei Sun, Beijing (CN)

(21) Appl. No.: 15/358,015

(22) Filed: Nov. 21, 2016

Related U.S. Application Data
(63) Continuation of application No. PCT/CN2015/093980, filed on Nov. 6, 2015.

(30) Foreign Application Priority Data
Nov. 7, 2014 (CN) PCT/CN2014/090607

(51) Int. Cl. H04W 4/00; H04W 72/04

(52) U.S. Cl. CPC H04W 4/005; H04W 72/042; H04W 72/0446; H04W 72/0453; H04W 72/048

(57) ABSTRACT

Methods and apparatus are provided for resource allocation for a physical data channel. In one novel aspect, the UE obtains plurality definitions of resource block and selects one definition of resource block based on one or more selection conditions. The plurality definitions of resource block have reduced number of resource elements as the standard PRB pair. In one embodiment, the UE selects a definition of resource block based on conditions including a physical channel data type, a UE type of MTC, a transmission mode of coverage enhancement, and a transmission type of small data transmission. In another novel aspect, long TTI resource allocation is used. The UE determines a TTI length of a transport block based on corresponding resource block assignment with more than two consecutive time domain subframes such that the transport block fit in the assigned resource blocks.

### CROSS REFERENCE TO RELATED APPLICATIONS

This application is filed under 35 U.S.C. §111(a) and is based on and hereby claims priority under 35 U.S.C. §120 and §365(c) from International Application No. PCT/CN2015/093980, with an international filing date of Nov. 6, 2015, which in turn claims priority from PCT Application No. PCT/CN2014090607, entitled, “METHODS FOR RESOURCE ALLOCATION” filed on Nov. 7, 2014. This application is a continuation of International Application PCT/CN2015/093980, which claims priority from PCT Application No. PCT/CN2014090607. International Application PCT/CN2015/093980 is pending as of the filing date of this application, and the United States is a designated state in International Application PCT/CN2015/093980. This application claims the benefit under 35 U.S.C. §119 from PCT Application No. PCT/CN2014090607. The disclosure of each of the forgoing documents is incorporated herein by reference.

### TECHNICAL FIELD

The disclosed embodiments generally relate to wireless communication, and, more particularly, to methods for resource allocation for a physical data channel.

### BACKGROUND

Machine type communication (MTC) applications require low-cost devices and improved coverage other than the current cellular communication system. Other narrow band (NB) devices also require coverage enhancement in a wireless network. The rapid growth in the latest development of the Internet of Things (IoT) also has requirements enhanced coverage mode. To achieve coverage enhancement, repetition is one common solution for most physical channels/signals. However, a large number of repetitions will cause high power consumption and shorten battery life. Solutions should be considered to reduce the number of repetitions for power consumption reduction and spectrum efficiency improvement.

Improvement and enhancement are required for new resource block definitions/configurations and new resource allocation methods to improve system efficiency.

### SUMMARY

Methods and apparatus are provided for resource allocation for a physical data.

In one novel aspect, the UE obtains plurality definitions/configurations of resource block and selects one definition/configuration of resource block based on one or more selection conditions. The UE determines a resource allocation for a physical data channel based on the selected definition/configuration of resource block and a resource block assignment for the physical data channel, for example DCI, and transmits or receives the physical data channel on the determined resource allocation. In one embodiment, the plurality definitions/configurations of resource block have the same total number of resource elements as the standard PRB pair. In another embodiment, the plurality types/definitions of resource block have a different total number of Res than the standard PRB pair. In one embodiment, the UE selects a definition of resource block based on one or more of the conditions including a physical channel data type, a UE type of machine type communication (MTC), a transmission mode of coverage enhancement, and a transmission type of small data transmission. In another embodiment, the UE selects a definition of resource block based on one or more of the indications including a RNTI type, a DCI format, a transmission mode of the physical data channel, and an indicator in DCI. In yet another embodiment, the resource block definition is selected based on one or more of the indications including a system information (SI), a UE specific RRC signaling, a higher layer signaling for coverage enhancement, a configuration of the physical data channel, and a UE category. In one embodiment, the resource allocation of the physical data channel is based on at least one of the conditions including: a number of resource blocks allocated for the physical data channel in time domain, a number of resource blocks allocated for the physical data channel in frequency domain, a location of resource blocks allocated for the physical data channel in the frequency domain, and a location of resource blocks allocated for the physical data channel in the time domain.

In one embodiment, a coverage enhancement mode is detected, and subsequently, a definition of resource block with less resource elements than standard PRB pair is selected. In another embodiment, PSD boosting is applied, and subsequently, a definition of resource block with less number of frequency domain subcarriers than standard PRB pair is selected.

In another novel aspect, a long TTI resource allocation method is used to support large packet size to reduce relative RLC/MAC/CRC overhead to improve efficiency. In one embodiment, the UE obtains one set of resource block allocation with more than two consecutive time domain subframes for a physical transport block such that the transport block spans in the allocated resource blocks for once mapping. This means the coded physical transport block is mapped to the allocated resource blocks cross more than two consecutive subframes, i.e. longer TTI length than 1 subframe. The UE transmits or receives the physical transport block on the allocated resource blocks. In one embodiment, the maximum number of allocable time domain subframes for a physical transport block is pre-determined. The size of the transport block is determined based on the total number of allocated resource blocks and modulation coding scheme (MCS). In another embodiment, a first number of allocated resource blocks in frequency domain is pre-determined and a second number of allocated resource blocks in time domain is dynamically indicated in DCI.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary wireless communication network with different definitions of resource block and longer TTIs in accordance with embodiments of the current invention.

FIG. 2 illustrates exemplary different definitions of resource block based on the current PRB definition of a LTE system in accordance with embodiments of the current invention.

FIG. 3 shows an example of one definition of resource block for smaller resource granularity in frequency domain for PSD boosting in accordance with the current invention.

FIG. 4 shows an example of one definition of resource block for smaller resource granularity in frequency domain for small data transmission.

FIG. 5 shows an example of one definition of resource block for smaller resource granularity in the time domain for small data transmission.

FIG. 6 shows an example of one definition of resource block to avoid 0.5 ms guard time for retuning.

FIG. 7 shows an example of UE behavior under multiple definitions of resource block in accordance with embodiments of the current invention.

FIG. 8 shows an exemplary flow chart of choosing one definition among multiple definitions of resource block in accordance with embodiments of the current invention.

FIG. 9 shows an example of resource allocation in time domain and frequency domain with long TTI of multiple frequency domain subcarriers in accordance with embodiments of the current invention.

FIG. 10 shows another example of resource allocation in time domain and frequency domain with long TTI of one frequency domain subcarrier in accordance with embodiments of the current invention.

FIG. 11 shows an exemplary flow chart of using different resource block definitions in accordance with embodiments of the current invention.

FIG. 12 shows an exemplary flow chart of using long TTI resource block in accordance with embodiments of the current invention.

### DETAILED DESCRIPTION

Reference will now be made in detail to some embodiments of the invention, examples of which are illustrated in the accompanying drawings.

A large number of repetitions will cause high power consumption and shorten battery life. Solutions should be considered to reduce the number of repetitions for power consumption reduction and spectrum efficiency improvement. One efficient solution is power spectral density (PSD) boosting. For PSD boosting, as receiving bandwidth is reduced, the total noise and interference power is decreased at the receiver side. Thus, the receiving Signal To Interference Noise Ratio (SINR) can be improved. Under the higher receiving SINR, channel estimation performance can be improved and the improved channel estimation performance can help to reduce the number of repetitions. Moreover, uplink PSD boosting can enable more UEs multiplexed in frequency domain within a given bandwidth as a reduced bandwidth is allocated for each UE. Therefore, uplink PSD boosting can significantly improve uplink cell capacity. In order to support PSD booting, some new resource allocation methods need to be introduced, including the new definition of resource block and the mechanism to obtain the resource allocation for data channel transmission and reception based on the new definition of resource block.

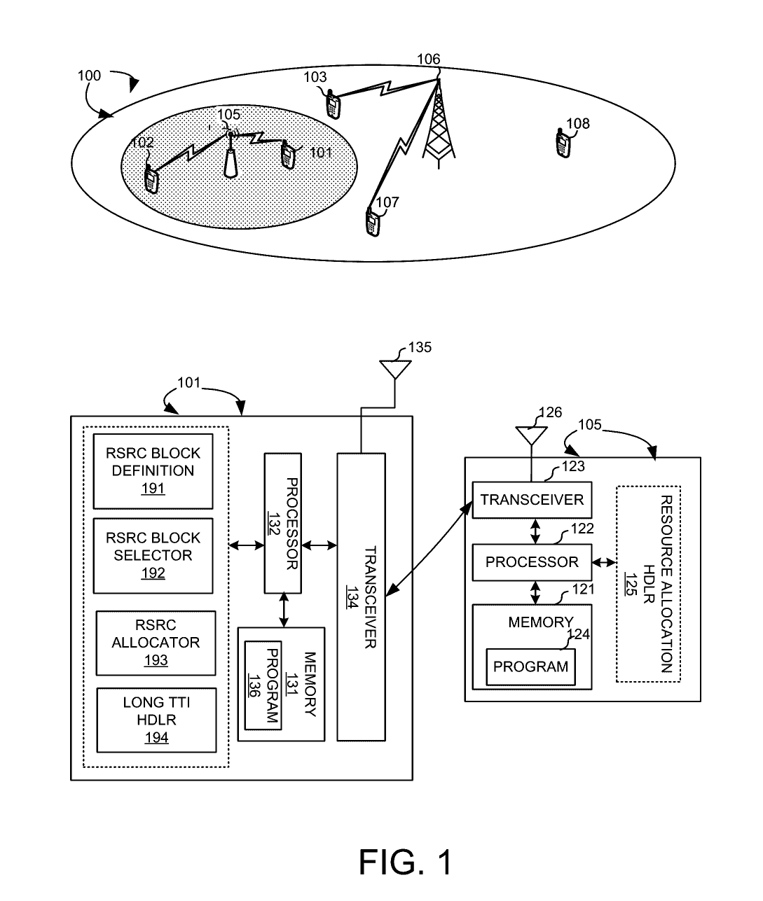

FIG. 1 illustrates an exemplary wireless communication network with different definitions of resource block and longer TTIs in accordance with embodiments of the current invention. Wireless communications system 100 includes one or more fixed base infrastructure units, such as wireless communications devices 105 and 106. The base unit may also be referred to as an access point, an access terminal, a base station, eNB, or by other terminology used in the art. Each of the wireless communications stations 105 and 106 serves a geographic area. The geographic area served by wireless communications stations 105 and 106 overlaps.

Wireless mobile station or user equipment (UE) 101 and 102 in the wireless network 100 are served by base station 105. Other wireless communications device, such as wireless communication device 103, 107 and 108, are served by a different base station 106. Mobile station 101 and 102 send uplink data to base stations 105 and 106 via uplink channels in the time and/or frequency domain. Mobile station 101 and 102 receives downlink data from base stations 105 and 106 via downlink channels. When there is a downlink packet to be sent from the eNB to the mobile station, each mobile station gets a downlink assignment, e.g., a set of radio resources in a physical downlink shared channel (PDSCH). When a UE needs to send a packet to eNodeB in the uplink, the mobile station gets a grant from the eNodeB that assigns a physical downlink uplink shared channel (PUSCH) consisting of a set of uplink radio resources. The mobile station gets the downlink or uplink scheduling information from a physical downlink control channel (PDCCH) or an enhanced physical downlink control channel (EPDCCH) that is targeted specifically to that mobile station. The downlink or uplink scheduling information and the other control information, carried by PDCCH, is referred to as downlink control information (DCI).

In one embodiment, the communication system utilizes Orthogonal Frequency Division Multiplexing Access (OFDMA) or a multi-carrier based architecture including Adaptive Modulation and Coding (AMC) on the downlink and next generation single-carrier (SC) based FDMA architecture for uplink transmissions. SC based FDMA architectures include Interleaved FDMA (IFDMA), Localized FDMA (LFDMA), DFT-spread OFDM (DFT-SOFDM) with IFDMA or LFDMA. In OFDMA based systems, remote units are served by assigning downlink or uplink radio resources that typically comprises a set of sub-carriers over one or more OFDM symbols. Exemplary OFDMA based protocols include the developing LTE/LTE-A of the 3GPP standard and IEEE 802.16 standard. The architecture may also include the use of spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading, or may be based on simpler time and/or frequency division multiplexing/multiple access techniques, or a combination of these various techniques. In alternate embodiments, communication system may utilize other cellular communication system protocols including, but not limited to, TDMA or direct sequence CDMA. The disclosure however is not intended to be limited to any particular wireless communication system.

FIG. 1 further shows simplified block diagrams of wireless stations 101 and base station 105 in accordance with the current invention.

Base station 105 has an antenna 126, which transmits and receives radio signals. A RF transceiver module 123, coupled with the antenna, receives RF signals from antenna 126, converts them to baseband signals and sends them to processor 122. RF transceiver 123 also converts received baseband signals from processor 122, converts them to RF signals, and sends out to antenna 126. Processor 122 processes the received baseband signals and invokes different functional modules to perform features in base station 105. Memory 121 stores program instructions and data 124 to control the operations of base station 105. Base station 105 also includes a set of control modules, such as resource allocation handler 125 that carry out functional tasks to configure, execute and communicate with the wireless communications device 101 for resource allocation related tasks.

Wireless communications device 101 has an antenna 135, which transmits and receives radio signals. A RF transceiver module 134, coupled with the antenna, receives RF signals from antenna 135, converts them to baseband signals and sends them to processor 132. RF transceiver 134 also converts received baseband signals from processor 132, converts them to RF signals, and sends out to antenna 135. Processor 132 processes the received baseband signals and invokes different functional modules to perform features in mobile station 101. Memory 131 stores program instructions and data 136 to control the operations of mobile station 101.

Wireless communications device 101 also includes a set of control modules that carry out functional tasks. A resource-block-definition handler 191 obtains plurality definitions of resource block, wherein each definition of resource block is defined by frequency domain subcarriers and time domain symbols. A resource block selector 192 selects one definition of resource block based on one or more selection conditions. A resource allocator 193 determines a resource allocation for a physical data channel based on the selected definition of resource and a resource block assignment for the physical data channel, for example, DCI. A long transmission time interval (TTI) handler 194 determines a TTI length of a transport block based on corresponding resource block assignment with more than two consecutive time domain subframes such that the transport block fits in the assigned resource blocks.

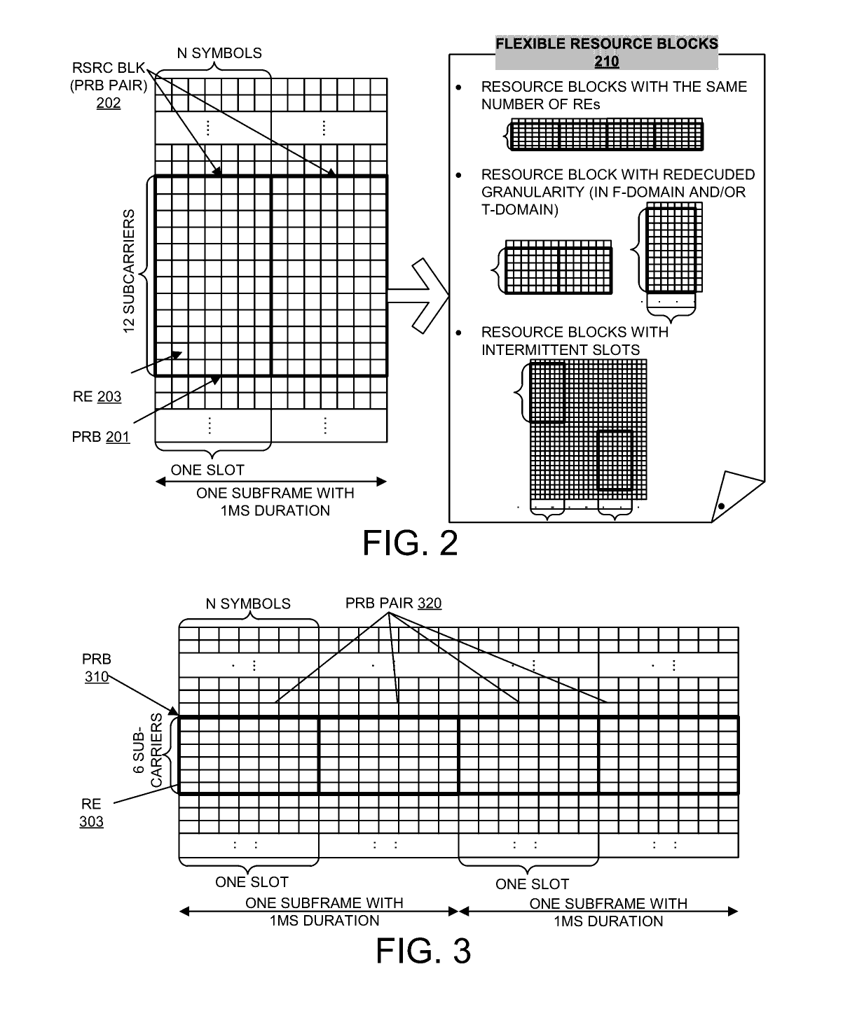

FIG. 2 illustrates exemplary different definitions of resource block based on the current PRB definition of a LTE system in accordance with embodiments of the current invention. A Physical resource block (PRB), such as PRB 201, is defined as 12 consecutive subcarriers in frequency domain and N consecutive symbols in time domain, wherein N is seven in the case of normal CP or six in the case of extended CP. The symbol is OFDM symbol for downlink or SC-FDMA symbol for uplink. Each OFDM/SC-FDMA symbol further consists of a number of subcarriers depending on the system bandwidth. The basic unit of the radio resource grid is called Resource Element (RE), such as RE 203, which spans a subcarrier over one OFDM/SC-FDMA symbol. The N OFDM/SC-FDMA symbols are called a slot, and one subframe consists of two consecutive slots with 1 ms duration, i.e. 1 ms transmission time interval (TTI). Two PRBs, which span two slots within one subframe, are called a PRB pair, such as PRB pair 202. The two PRBs occupy the same frequency location, or are staggered cross-slot in different frequency locations. A PRB pair is the basic unit of resource allocation, i.e. resource granularity. For simplification, the PRB pair is called for short PRB when describing resource allocation.

For downlink, the first one to four OFDM symbols are used for control region and remaining OFDM symbols are used for PDSCH. For uplink, one SC-FDMA symbol within each slot is used for DMRS, and remaining SC-FDMA symbols are used for PUSCH. In the LTE system, the information of resource block(s) allocated for a physical data channel is indicated with a resource-block-assignment field in a DCI, e.g. the location and the number of resource block(s) allocated in frequency domain. The UE will interpret the resource-block-assignment field to determine the resource allocated for the physical data channel, and then transmit or receive the physical data channel on the determined resource.

In 3GPP Rel-13 machine-type communication (MTC) working-item description (WID), 15 dB coverage enhancement is proposed for low complexity MTC UE or other LTE UEs to achieve the target of absolute 155.7 dBm maximum coupling loss (MCL). In order to achieve the target of coverage enhancement, repetition is one common solution, which is simple and efficient for most physical channels/signals. However, a large number of repetitions will cause high power consumption and shorten battery life, especially for uplink transmission. Considering power consumption and spectrum efficiency, the number of repetitions should be reduced to an acceptable level. There are multiple solutions captured in 3GPP technical report (TR) 36.888, e.g. frequency hopping, cross-subframe channel estimation, DMRS density increasing, power boosting, power spectrum density (PSD) boosting, and so on. Among these solutions, power boosting means more power can be used by the eNB on the downlink transmission to a MTC UE, and PSD boosting means a given level of power can be concentrated into a reduced bandwidth at the eNB or the UE. Power boosting or PSD boosting can directly improve receiving SINR because the total noise and interference power is decreased within a reduced receiving bandwidth. Under a higher receiving SINR, channel estimation performance can be improved. Consequently, the number of repetitions and the total transmission time can be reduced to further reduce power consumption. In addition, comparing with downlink power boosting, uplink PSD boosting can enable more UEs multiplexed in frequency domain within a given bandwidth and remarkably improve the uplink cell capacity and spectrum efficiency.

If a given level of power is boosted to as small bandwidth as possible, the maximal PSD boosting gain can be achieved. For example, uplink PSD boosting is used for one PRB, which is the minimum resource granularity in current LTE system. Since the uplink PSD boosting gain depends on the occupied bandwidth in frequency domain, a smaller resource granularity than twelve subcarriers can be considered. If uplink PSD boosting is used with a smaller resource granularity, for example, six subcarriers in frequency domain, receiving SINR can be further improved by about 3 dB since the noise power at the receiver is reduced to half with the reduction of occupied bandwidth. The number of UEs multiplexed within one subframe can be double and the uplink cell capacity can be improved by about twice. Furthermore, the number of repetitions, as well as the total transmission time can be reduced, which can help on power consumption reduction. The definition of smaller resource granularity may be just used for PUSCH repetition. In one example, one UE with PUSCH repetition and another UE without PUSCH repetition may use different definitions of resource block. In another example, one UE may use smaller resource granularity for PUSCH repetition and use normal resource granularity for PDSCH repetition.

FIG. 2 also shows exemplary definitions/configurations of flexible resource block 210. In one embodiment, resource block is defined/configured with the same number of REs as the current PRB pair. The number of frequency domain subcarriers can be defined/configured to be less than the standard twelve while the number of symbols in the time domain can be defined/configured larger than the standard fourteen. In another embodiment, flexible resource block can be configured/defined with reduced granularity, either in the frequency domain, or in the time domain, or in both. As shown, a new resource block can be defined/configured with only six frequency domain subcarriers. In another example, the resource block has reduced time domain symbols. In yet another embodiment, the resource block can be defined/configured with intermittent slots in the time domain. Such definition/configuration helps with frequency tuning for devices such as the MTC device.

FIG. 3 shows an example of one definition of resource block for smaller resource granularity in frequency domain for PSD boosting in accordance with the current invention. One resource block is defined as six consecutive subcarriers in frequency domain and twenty-eight consecutive symbols in time domain in the case of normal CP. In the definition, the total number of REs, such as RE 303, within a resource block is same to current one PRB, for example, 6*28=12*14=168 REs. Similar to current definition of PRB and PRB pair, one PRB, such as PRB 310, contains six subcarriers and seven symbols in the case of normal CP. One PRB pair, such as PRB pair 320, contains four PRBs. Similarly, the four PRBs occupy the same frequency location, or are staggered cross-slot and cross-subframe in different frequency locations with a predefined hopping pattern. In the definition of resource block, TTI is 2 ms.

In another example, one resource block is defined as four consecutive subcarriers in frequency domain and forty-two consecutive symbols in time domain in the case of normal CP. In the definition, TTI is 3 ms. In another example, one resource block is defined as three consecutive subcarriers in frequency domain and fifty-six consecutive symbols in time domain in the case of normal CP. In the definition, TTI is 4 ms.

Another use case of smaller resource granularity is small data transmission, such as ultra-small data packet in the MTC service. Since MTC data packets are generally intermittent and the time interval may be several minutes or hours, conjunction/combination of multiple data packets may cause an unacceptable latency. Current LTE system aiming for normal data transmission may not be suitable for small data transmission. In the current LTE system, the minimum TBS is sixteen bits for one PRB and modulation and coding scheme (MCS) is set to zero. However, the ultra-small data packet size may be less than sixteen in the MTC service. For the kind of ultra-small data packet, one PRB may be redundant even with the lowest MCS. In addition, channel quality may be very good and be able to support a higher MCS. However, the data packet size may be less than the TBS under the higher MCS and one PRB. Though a lower MCS can be used to fill the small data packet into one PRB, it is not efficient. In this case, the smaller resource granularity may be efficient to improve cell capacity and spectrum efficiency for both downlink and uplink. For example, one resource block may be defined as six subcarriers and fourteen symbols, which is smaller resource granularity in the frequency domain. Alternatively, one resource block may be defined as twelve subcarriers and seven symbols, which is smaller resource granularity in the time domain. The definition of smaller resource granularity is used for small data transmission. Thus, MTC UE with small data transmission may use smaller resource granularity and other UEs with normal data transmission may use normal resource granularity. For the smaller resource granularity, the total number of REs in each PRB will be smaller. In one embodiment, additional TBS table is required for smaller granularity resource blocks.

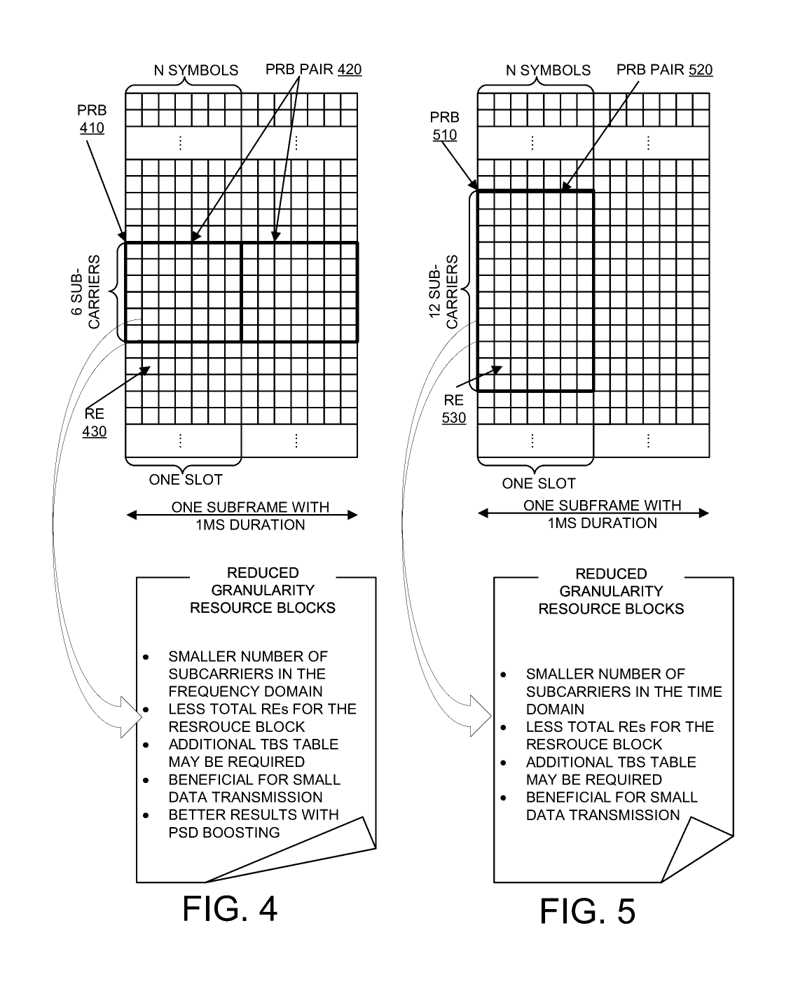

FIG. 4 shows an example of one definition of resource block for smaller resource granularity in frequency domain for small data transmission. One resource block is defined as six consecutive subcarriers in frequency domain and fourteen consecutive symbols in time domain in the case of normal CP. In the definition, the total number of REs within a resource block is half of current one PRB, i.e. 6*14=84 REs, such as RE 430. Similar to current definition of PRB and PRB pair, one PRB, such as PRB 410, contains six subcarriers and seven symbols, and one PRB pair, such as PRB pair 420, contains two PRBs. Similarly, the two PRBs occupy the same frequency location, or are staggered cross-slot in different frequency locations with a predefined hopping pattern.

FIG. 5 shows an example of one definition of resource block for smaller resource granularity in the time domain for small data transmission. One resource block is defined as twelve consecutive subcarriers in frequency domain and seven consecutive symbols in time domain in the case of normal CP. In the definition, the total number of REs within a resource block is half of current one PRB 510, i.e. 12*7=84 REs, wherein RE 530 is an example. Different from current definitions, a PRB pair 520 just contains one PRB in one slot. And the slot may be the first slot or the second slot. One UE is allocated on the first slot, and another UE is allocated on the second slot. Thus, from eNB perspective, there is no resource waste.

For Rel-13 low complexity MTC UE, both RF and baseband bandwidth is reduced to 1.4 MHz for both downlink and uplink. Thus, resource allocation is within six contiguous PRBs, which can be called MTC operation band. The location of downlink MTC operation band may be different for broadcast transmission and unicast transmission, e.g. central six PRBs and configured six PRBs respectively. Similarly, the uplink MTC operation band may be different depending on uplink physical channel, such as PRACH and PUSCH. In addition, frequency hopping is an important technology to achieve frequency diversity gain especially for reduced bandwidth. Therefore, RF retuning cross multiple MTC operation bands is necessary either semi-statically or dynamically. The RF retuning time is generally several hundred microseconds, and 0.5 ms guard time can be defined and sufficient for retuning.

In order to conveniently retuning, the resource block may be redefined. In one example, one resource block may be defined as twelve subcarriers in the frequency domain and two intermitted slots in the time domain, wherein there are fourteen symbols in time domain and the total number of REs within one PRB is the same to current one PRB. The new defined PRB spans two subframes and occupies the first slot or the second slot within each subframe. Thus, MTC UE with retuning may use the new definition of resource block to avoid the guard time for retuning, and other UE without retuning may use legacy definition of resource block.

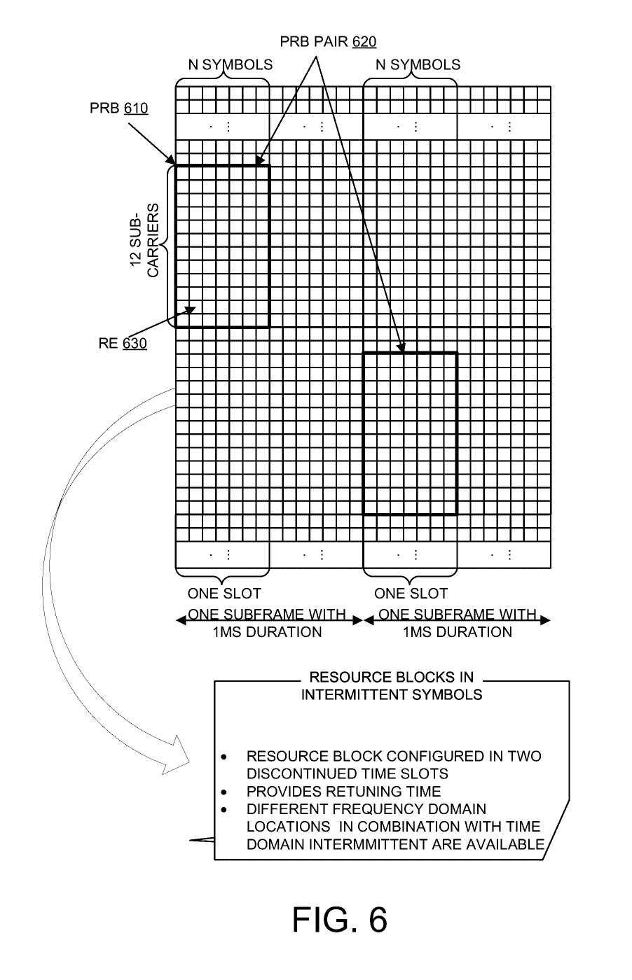

FIG. 6 shows an example of one definition of resource block to avoid 0.5 ms guard time for retuning. One Resource block is defined as twelve consecutive subcarriers in the frequency domain and fourteen intermittent symbols in time domain in the case of normal CP. In the definition, TTI is 2 ms. The resource block spans two subframes and occupies the first slot or the second slot within each subframe. One UE is allocated to the first slot, and another UE is allocated to the second slot. Thus, from eNB perspective, there is no resource waste. The two PRBs occupy different frequency locations with a predefined/pre-determined hopping pattern. One resource block is defined as twelve consecutive subcarriers in frequency domain and seven consecutive symbols in time domain in the case of normal CP. In the definition, the total number of REs within a resource block is that one PRB 610, i.e. 12*7=84 REs, wherein RE 630 is an example. A PRB pair 620 just contains two PRBs in two slots.

There may be multiple definitions of resource block for different use cases in the LTE system or other type of communication systems. Here, the definition of resource block includes definition of PRB and definition of PRB pair (i.e. the basic unit of resource allocation). Regarding the redefinition of resource block, one case is that the total number of REs is the same to one current PRB, e.g. six subcarriers and twenty-eight symbols (6*28=12*14=168 REs). In another word, the resource block is compressed in frequency domain and stretched in time domain. In this case, no additional TBS table is required and impact to specification is small. The definition with smaller resource granularity in frequency domain can be used for uplink PSD boosting. Another case is that the total number of REs is smaller than current PRB. For example, the number of subcarriers in frequency domain is smaller, e.g. six subcarriers and fourteen symbols (6*14=84 REs), or the number of symbols in time domain is smaller, e.g. twelve subcarriers and seven symbols (12*7=84 REs). In this case, additional TBS table maybe required. The definition with fewer RE number can be used for small data transmission.

If there are multiple definitions of resource block and some definition (e.g. smaller resource granularity) is just used for some special case (e.g. PUSCH repetition or small data transmission), UE behaviors will be different from that under only one definition of resource block. For example, UE needs to choose one definition among the multiple definitions of resource block when determining a resource allocation for a physical data channel.

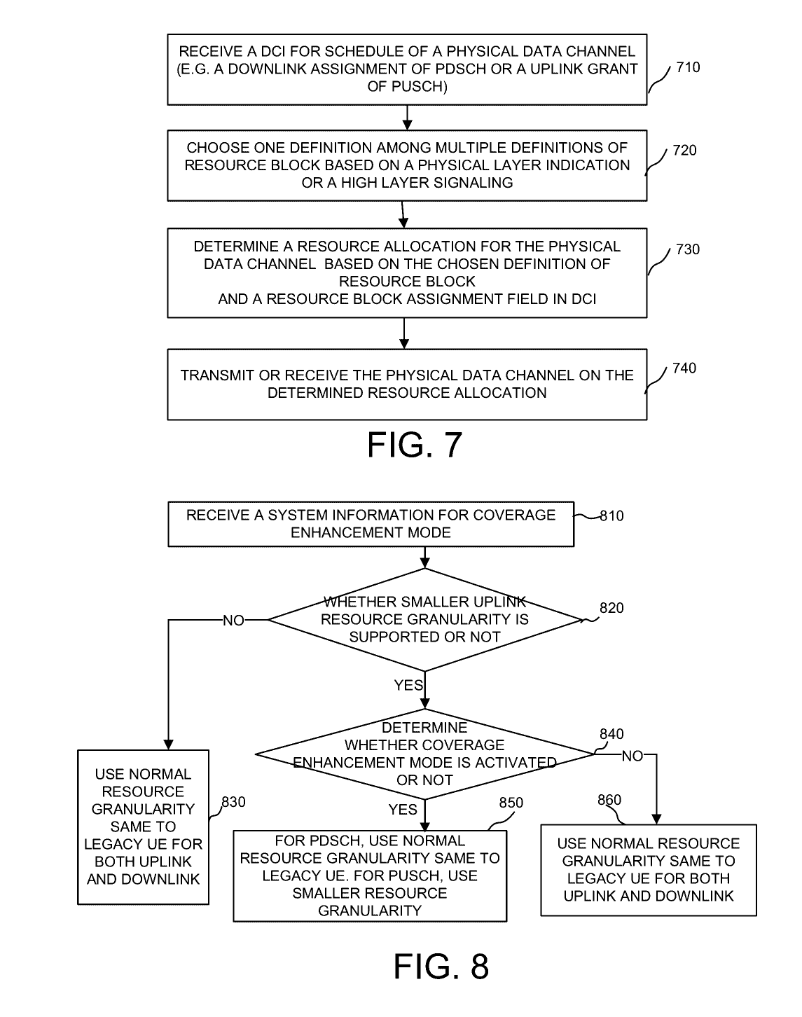

FIG. 7 shows an example of UE behavior under multiple definitions of resource block in accordance with embodiments of the current invention. In step 710, when UE receives a resource block assignment, for example, a DCI for scheduling of a physical data channel (e.g. a downlink assignment of PDSCH or an uplink grant of PUSCH), in step 720 UE chooses one definition from the multiple definitions of resource block to interpret resource allocation indicated by the resource block assignment field in DCI. In step 730 based on the chosen definition and resource block assignment field in DCI, UE determines the resource block(s) allocated for the physical data channel. Then, in step 740 UE transmits or receives the physical data channel on the determined resource block(s).

In one embodiment, choosing one definition among the multiple definitions of resource block is based on the at least one of the following terms: physical channel data type (e.g. PDSCH or PUSCH), the UE category/type (e.g. MTC UE or non-MTC UE), whether a special feature is enabled or not (e.g. coverage enhancement mode or small data transmission). Based on the chosen definition of resource block, the resource allocation for the physical data channel is determined. And then the physical data channel is received or transmitted on the determined resource allocation.

In one example, the UE chooses one definition among the multiple definitions of resource block based on a physical layer indication. The physical layer indication is implied by a physical parameter. The physical parameter may be RNTI type used to scramble the CRC of DCI, DCI format, and resource allocation type, transmission mode of the physical data channel or the physical data channel type. Alternatively, the physical layer indication is explicitly indicated in the DCI with a dedicated field, e.g. one bit or two bits used to indicate which definition of the multiple definitions of resource block.

In one embodiment, for small data transmission, it is generally aiming for unicast transmission, and the payload size of broadcast transmission may not be small, e.g. SIB, paging or RAR. Thus, unicast transmission and broadcast transmission may use different definitions of resource block. For broadcast transmission and unicast transmission, the RNTI types used to scramble the CRC of DCI are different, e.g. SI-RNTI/P-RNTI/RA-RNTI for broadcast transmission and C-RNTI for unicast transmission. Therefore, definition of resource block can be implied by RNTI type.

In one embodiment, choosing one definition among multiple definitions of resource block is implied by the RNTI type used to scramble the CRC of DCI. If the RNTI is SI-RNTI for system information, P-RNTI for paging, RA-RNTI for random access response, or other RNTIs for other broadcast transmission, corresponding definition of resource block is chosen, e.g. normal resource granularity in FIG. 2. If the RNTI is C-RNTI for unicast transmission, corresponding definition of resource block is chosen, such as smaller resource granularity in FIG. 4.

For coverage enhancement mode, a new compact DCI format with smaller payload size is designed to reduce repetition number of physical control channel, and the repetition number is indicated explicitly or implicitly in the compact DCI. Thus, DCI formats used for coverage enhancement mode and normal coverage may be corresponding to different definitions of resource block respectively. In this case, definition of resource block can be implied by the DCI format.

In one embodiment, choosing one definition among multiple definitions of resource block is implied by DCI format. If the DCI format is used to schedule a normal transmission without repetition, corresponding definition of resource block is chosen, e.g. normal resource granularity in FIG. 2. If the DCI format is used to schedule a repeated transmission, corresponding definition of resource block is chosen, e.g. smaller resource granularity in FIG. 4.

For smaller resource granularity, a new resource allocation type may be used since the number of resource blocks within system bandwidth or a given bandwidth is different under different definitions of resource block. In one embodiment, choosing one definition among multiple definitions of resource block is implied by the resource allocation type. Each resource allocation type corresponds to a predefined definition. And the resource allocation type is indicated in the DCI. According to the resource allocation type, corresponding definition of resource block is chosen.

For coverage enhancement mode, a new transmission mode is designed, wherein a special design is used for channel quality measurement and report, physical resource mapping, demodulation RS and so on. Thus, the transmission modes for coverage enhancement mode and normal coverage may use different definitions of resource block. In one embodiment, choosing one definition among multiple definitions of resource block is implied by the transmission mode of physical data channels. If the transmission mode is used for coverage enhancement mode, corresponding resource block is chosen, e.g. smaller resource granularity in FIG. 3. If the transmission mode is for normal coverage, corresponding definition of resource block is chosen, e.g. normal resource granularity in FIG. 2.

In one example, the maximum number of allocated resource blocks in frequency domain could be predetermined. And the number of allocated resource blocks in frequency domain is predefined/pre-determined between one and the maximum number, for example one. If only one UE is scheduled with a smaller resource granularity, one legacy resource block with the definition of normal granularity cannot be fully occupied. Thus, remaining resources within the legacy resource block will be wasted. In this case, it may be beneficial to schedule the UE with normal resource granularity. Therefore, the resource granularity may dynamically change. The change of resource granularity depends on the channel quality, the data packet size, and the whole status of resource allocation. In order to dynamically change the resource granularity, it can be indicated by a physical layer signaling, e.g. an indicator in the DCI.

In one embodiment, choosing one definition among multiple definitions of resource block is based on an indicator in DCI. A dedicated field is used to indicate the level of resource granularity, e.g. 1 bit wherein bit ‘0’ is for normal resource granularity in FIG. 2, and bit ‘1’ is for smaller resource granularity in FIG. 3. If there are multiple levels of resource granularity, e.g. 12, 6, 4, or 3 subcarriers, a field of 2 bits can be used.

Though smaller granularity is beneficial for uplink repetition and small data transmission, it may be an optional feature at eNB side. eNB may not be able to support smaller resource granularity. If there are multiple definitions for different levels of smaller resource granularity (e.g. six subcarriers and three subcarriers), each eNB may use at least one different definition. Thus, eNB should indicate the information in system information or by a UE specific RRC signaling. And the system information or the UE specific RRC signaling is used for some special case wherein smaller resource granularity is used.

In one embodiment, choosing one definition among the multiple definitions of resource block is based on system information. The system information is an information element (IE) in current system information block, or a new designed system information block. The IE in current system information block or the new designed system information block is used for a special feature (e.g. coverage enhancement mode or small data transmission), a special UE category/type (e.g. MTC UE), or a special physical data channel type (e.g. PDSCH or PUSCH). The definition of resource block is explicitly indicated with a dedicated field in the system information, e.g. one bit or two bits used to indicate which definition among the multiple definitions of resource block. Alternatively, the definition of resource block is implied by the system information. For example, if the special feature (e.g. coverage enhancement mode or small data transmission) is enabled by the system information, corresponding definition of resource block is used.

In another example, one resource block is defined as four consecutive subcarriers in frequency domain and fourteen consecutive symbols in time domain in the case of normal CP. In the definition, the total number of REs within a resource block is 4*14=56 REs. In another example, resource block is defined as three consecutive subcarriers in frequency domain and fourteen consecutive symbols in time domain in the case of normal CP. In the definition, the total number of REs within a resource block is 3*14=42 REs.

FIG. 8 shows an exemplary flow chart of choosing one definition among multiple definitions of resource block in accordance with embodiments of the current invention. In the example, smaller resource granularity is used for coverage enhancement mode. The eNB indicates whether the smaller uplink resource granularity is supported or not in system information. In step 810, the UE receives system information, which includes the coverage enhancement mode. In the system information there is a field to indicate whether smaller uplink resource granularity is supported. In step 820 UE detects whether the smaller uplink resource granularity is supported or not. If the smaller uplink resource granularity is not supported, the UE goes to step 830. The UE uses normal resource granularity the same as the legacy UE for both uplink and downlink. If smaller uplink resource granularity is supported, the UE goes to step 840. The UE determines whether coverage enhancement mode is activated. If coverage enhancement mode is not activated, in step 850, the UE uses normal resource granularity same to legacy UE for both uplink and downlink. If the coverage enhancement mode is activated, in step 860, the normal resource granularity (e.g. FIG. 2) is used for PDSCH, and smaller resource granularity (e.g. FIG. 3) is used for PUSCH by the UE.

In one embodiment, choosing one definition among the multiple definitions of resource block is based on a high layer signaling and the high layer signaling is UE specific RRC signaling. The UE specific RRC signaling is used for a special feature (e.g. coverage enhancement mode or small data transmission), or a special UE category/type (e.g. MTC UE), or a special physical data channel type (e.g. PDSCH or PUSCH). The definition of resource block is explicitly indicated with a dedicated field in the UE specific RRC signaling, e.g. one bit or two bits used to indicate which definition among the multiple definitions of resource block. Alternatively, the definition of resource block is implied by the RRC signaling. For example, if the special feature (e.g. coverage enhancement mode or small data transmission) is activated with the UE specific RRC signaling, corresponding definition of resource block is used.

In one embodiment, choosing one definition of resource block among multiple definitions of resource block is based on the type of physical data channel, e.g. PUSCH or PDSCH. Since smaller uplink resource granularity can additionally improve cell capacity, uplink resource block and downlink resource block may use different definitions. In one example, PDSCH use one definition of resource block, e.g. normal resource granularity in FIG. 2. PUSCH use another definition of resource block, e.g. smaller resource granularity in FIG. 3.

In LTE system, a resource-block-assignment field in DCI is used to indicate the location and the number of PRB(s) allocated in the frequency domain. However, the current resource allocation just in frequency domain may not be efficient for MTC UEs using PSD boosting. In order to support a larger data packet size (i.e. a larger TBS under a given MCS) or a bad channel quality (i.e. a lower MCS under a given TBS), the number of allocated PRB(s) may be greater than one. In this case, if a given level of power is still boosted to the minimum resource granularity in frequency domain, the multiple PRBs can be allocated in time domain. Thus, one transmission of a physical data channel may occupy several subframes and it can be accepted since MTC service is latency tolerant. Scheduling will be more flexible and an appropriate number of PRB can be allocated in time domain and frequency domain to match the channel quality and the data packet size.

Different from traditional resource allocation in frequency domain, the allocated PRB(s) is consecutive in time domain. The PRBs allocated in time domain may occupy the same frequency location or different frequency locations with a predefined hopping pattern, which is similar to current mechanism of the two PRBs within a PRB pair. The number of PRB allocated in time domain shall be indicated in DCI, e.g. a dedicated field or within current resource-block-assignment field. The maximum number of PRB allocated in time domain shall be predefined or semi-statically configured with a high layer signaling.

In one embodiment, determining a resource allocation for a physical data channel for a UE is based on at least one of following information: the number of resource block(s) allocated for the physical data channel in time domain; the number of resource block(s) allocated for the physical data channel in frequency domain; the location of resource block(s) allocated for the physical data channel in frequency domain.

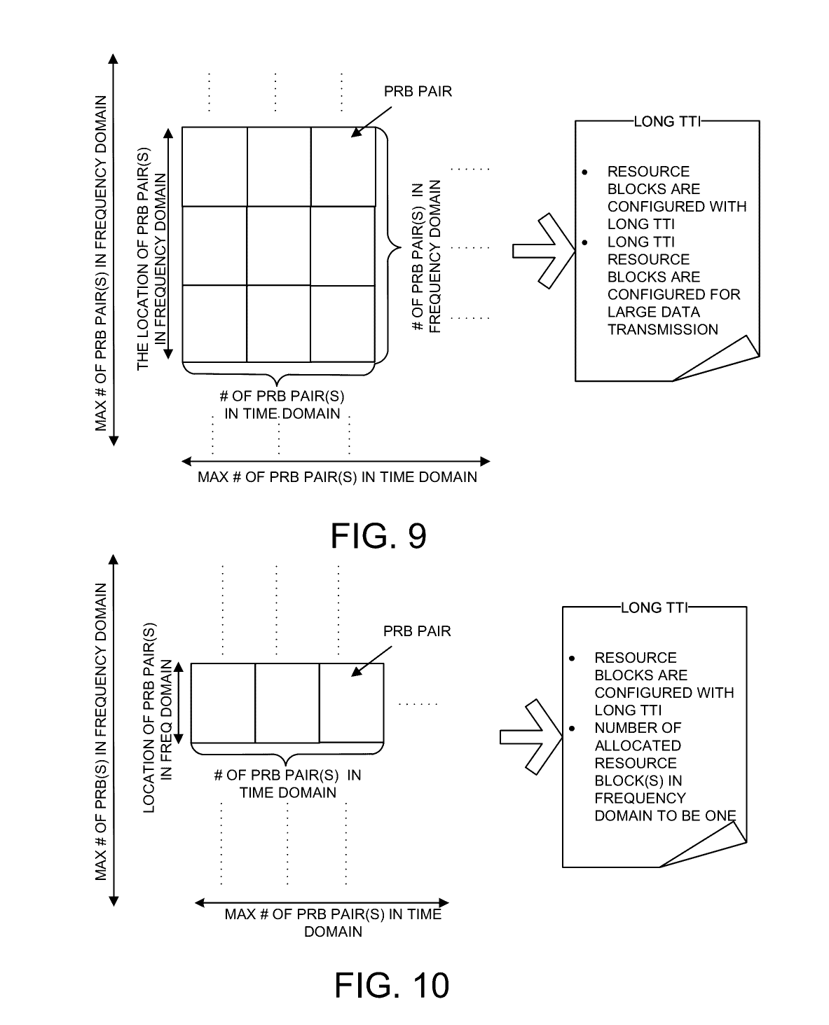

FIG. 9 shows an example of resource allocation in time domain and frequency domain with long TTI in accordance with embodiments of the current invention. In this example, the maximum number of schedulable resource block(s) in frequency domain depends on the maximum receiving bandwidth of the UE for downlink or the maximum transmitting bandwidth of the UE for uplink. The maximum number of schedulable resource block(s) in time domain is a pre-determined value (e.g. ten). Thus, log₂ (10) bits is used to indicate the number of resource block(s) allocated in time domain with a dedicated field in DCI. A resource-block-assignment field is used to indicate the number and location of resource block(s) allocated in frequency domain in DCI. The pre-determined value can be defined in the standard specification. The pre-determined value can be also configured by the eNB. Further, the pre-determined value can be configured through high level signaling, such as configuration through the RRC messages, such as SIB or DCI.

FIG. 10 shows another example of resource allocation in time domain and frequency domain with long TTI and a fixed resource blocks in the frequency domain in accordance with embodiments of the current invention. Similar to FIG. 9, the maximum number of schedulable resource block(s) in time domain is pre-determined. The number of resource blocks in frequency domain is fixed, i.e. pre-determined, and it need not be indicated in resource block assignment filed in DCI. The number of resource block(s) allocated in frequency domain is pre-determined as one. The number of resource block(s) allocated in time domain and the location of resource block(s) in frequency domain need to be indicated in resource allocation field of DCI. In another example, the number of resource block(s) in frequency domain is predefined/pre-determined and greater than one. In FIG. 10, the resource allocation filed of DCI indicates that, for one transport block, there are three PRB pairs in time domain, in other word, UE could obtain the resource allocation with three consecutive time domain subframes for a physical transport block such that the physical transport block spans in the above three consecutive time domain subframes for once mapping. And the UE could transmit or receive the physical transport block on the allocated resource.

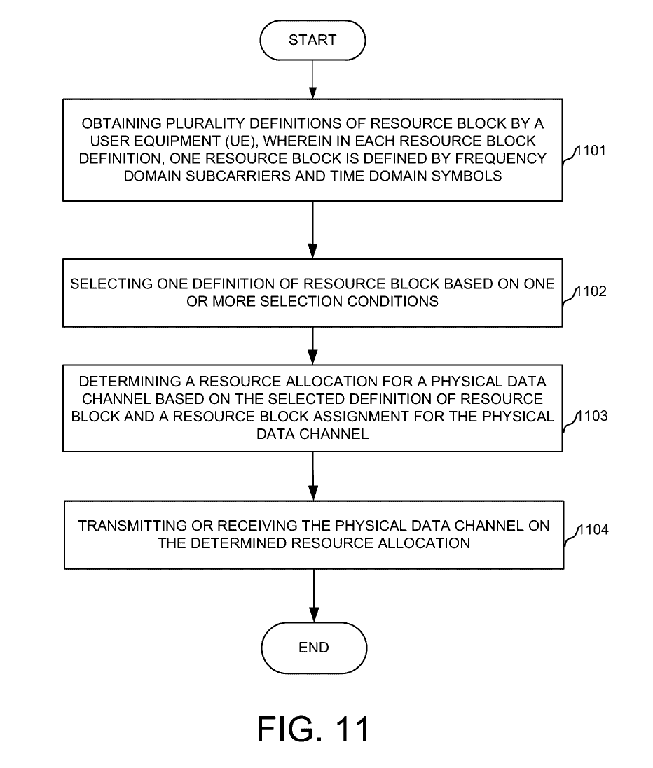

FIG. 11 shows an exemplary flow chart of using different resource block definitions in accordance with embodiments of the current invention. At step 1101, the UE obtains plurality definitions of resource block, wherein in each resource block definition, one resource block is defined by frequency domain subcarriers and time domain OFDMA/SC-FDMA symbols. At step 1102, the UE selects one definition of resource block based on one or more selection conditions. At step 1103, the UE determines a resource allocation for a physical data channel based on the selected definition of resource block and the information of resource block assignment for the physical data channel. At step 1104, the UE transmits or receives the physical data channel on the determined resource allocation.

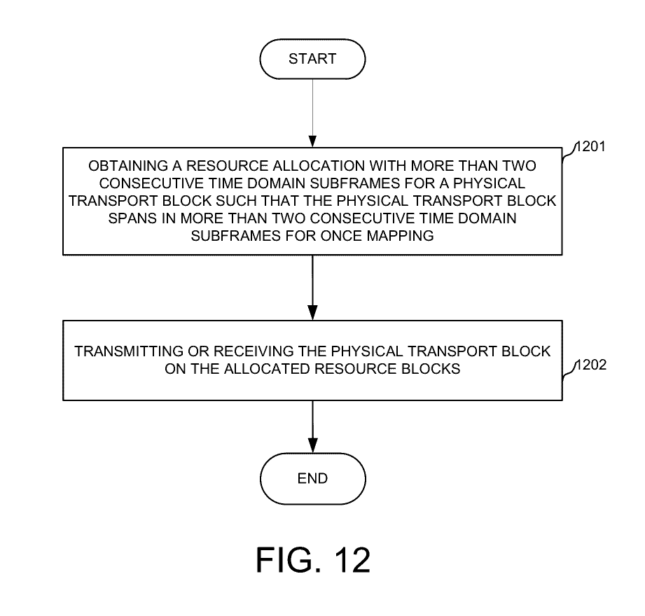

FIG. 12 shows an exemplary flow chart of using long TTI resource block in accordance with embodiments of the current invention. At step 1201, the UE obtains a resource block allocation with more than two consecutive time domain subframes for a physical transport block such that the physical transport block fits in the allocated resource blocks. At step 1202, the UE transmits or receives the physical transport block on the assigned resource blocks.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
obtaining plurality definitions of resource block by a user equipment (UE), wherein in each resource block definition, one resource block is defined by frequency domain subcarriers and time domain symbols;
selecting one definition of resource block based on one or more selection conditions;
determining a resource allocation for a physical data channel based on the selected definition of resource block and a resource block assignment for the physical data channel; and
transmitting or receiving the physical data channel on the determined resource allocation.

2. The method of claim 1, wherein each of the plurality definitions of resource block have the same total number of resource elements (REs) as standard physical resource block (PRB) pair.

3. The method of claim 1, wherein at least one of the plurality definitions of resource block have a different total number of resource elements (REs) from standard physical resource block (PRB) pair.

4. The method of claim 3, wherein the plurality definitions of resource block are associated with different transport block size (TBS) tables.

5. The method of claim 1, wherein the selection conditions comprising: a physical channel data type, a UE type of machine type communication (MTC), a transmission mode of coverage enhancement, and a transmission type of small data transmission.

6. The method of claim 1 wherein the selection condition is indicated by a physical layer indication comprising: a RNTI type, a DCI format, a transmission mode of the physical data channel, and a dedicated indicator in DCI.

7. The method of claim 1 wherein the selection condition is indicated by a higher layer signaling comprising: a system information (SI), a UE specific RRC signaling, a higher layer signaling for coverage enhancement, a configuration of the physical data channel, and a UE category.

8. The method of claim 1 wherein determining the resource allocation for the physical data channel bases on at least one conditions comprising: a number of resource blocks allocated for the physical data channel in time domain, a number of resource blocks allocated for the physical data channel in frequency domain, a location of resource blocks allocated for the physical data channel in the frequency domain, and a location of resource blocks allocated for the physical data channel in the time domain.

9. The method of claim 7, wherein the number of allocated resource blocks in time domain is indicated in DCI.

10. The method of claim 1, wherein a coverage enhancement condition is detected, and subsequently, one definition of resource block with less resource elements than standard PRB pair is selected.

11. The method of claim 1, wherein power spectral density (PSD) boosting is applied, and subsequently, one definition of resource block with less number of frequency domain subcarriers than standard PRB pair is selected.

12. A method comprising:
obtaining a resource allocation with more than two consecutive time domain subframes for a physical transport block such that the physical transport block spans in more than two consecutive time domain subframes for once mapping; and
transmitting or receiving the physical transport block on the allocated resource.

13. The method of claim 12, wherein a maximum number of allocable time domain subframes is pre-determined.

14. The method of claim 12, wherein a number of allocated frequency domain resource blocks and a location of the resource blocks allocated in the frequency domain are indicated in DCI.

15. The method of claim 12, wherein a number of allocated frequency domain resource blocks is predetermined

16. The method of claim 12, wherein a number of allocated time domain subframes and a location of the resource block allocated in the time domain are indicated in the DCI.

17. An apparatus, comprising:
a resource block definition handler that obtains plurality definitions of resource block, wherein each definition of resource block is defined by frequency domain subcarriers and time domain symbols;
a resource block selector that selects one definition of resource block based on one or more selection conditions;
a resource allocator that determines a resource allocation for a physical data channel based on the selected definition of resource and a resource block assignment for the physical data channel; and
a radio frequency transceiver that transmits or receives the physical data channel on the determined resource allocation.

18. The apparatus of claim 17, wherein the selection conditions comprising: a physical channel data type, a UE type of machine type communication (MTC), a transmission mode of coverage enhancement, and a transmission type of small data transmission.

19. The apparatus of claim 17, further comprising: a long transmission time interval (TTI) handler that determines a TTI length of a transport block based on corresponding resource block assignment with more than two consecutive time domain subframes such that the transport block fit in the assigned resource blocks.
